(19) United States
(12) Patent Application Publication
(10) Pub. No.: US 2019/0180506 A1
(43) Pub. Date: Jun. 13, 2019

(54) SYSTEMS AND METHODS FOR ADDING ANNOTATIONS TO VIRTUAL OBJECTS IN A VIRTUAL ENVIRONMENT

(71) Applicant: Tsunami VR, Inc., Del Mar, CA (US)

(72) Inventors: Morgan Nicholas GEBBIE, Carlsbad, CA (US); Anthony DUCA, Carlsbad, CA (US); Beth BREWER, Escondido, CA (US); Archie THORNTON, Carlsbad, CA (US); Kyle PENDERGRASS, San Diego, CA (US)

(21) Appl. No.: 16/216,066

(22) Filed: Dec. 11, 2018

Related U.S. Application Data
(60) Provisional application No. 62/597,378, filed on Dec. 11, 2017.
(60) Provisional application No. 62/599,769, filed on Dec. 17, 2017.

(51) Int. Cl. G06T 19/00

(52) U.S. Cl. CPC G06T 19/00; G06T 2219/004

(57) ABSTRACT

Systems, methods, and computer readable media for modifying a virtual object in a virtual environment are provided. The method can include receiving at one or more processors, an identification of the virtual object within the virtual environment. The method can include receiving, from a first user device communicatively coupled to the one or more processors, an annotation including one or more changes to be applied to the virtual object. The method can include determining a type of the one or more changes based on the annotation. The method can include determining a location of the one or more changes to the virtual object based on the annotation. The method can include causing the virtual object to be modified as a modified virtual object using a computer-aided design (CAD) software program to implement the changes indicated in the annotation and displaying the modified virtual object within the virtual environment.

### CROSS REFERENCE TO RELATED APPLICATIONS

This application claims priority to U.S. Provisional Patent Application Ser. No. 62/597,378, filed Dec. 11, 2017, entitled “SYSTEMS AND METHODS FOR MAKING SMART ANNOTATIONS,” and to U.S. Provisional Patent Application Ser. No. 62/599,769, filed Dec. 17, 2017, entitled “SYSTEMS AND METHODS FOR ADDING ANNOTATIONS TO VIRTUAL OBJECTS IN A VIRTUAL ENVIRONMENT,” the contents of which are hereby incorporated by reference in their entirety.

### BACKGROUND

### Technical Field

This disclosure relates to virtual reality (VR), augmented reality (AR), and hybrid reality technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics. Certain aspects of one or more virtual objects within a given virtual environment may need adjustment, correction, or other changes for a multitude of reasons.

### SUMMARY

An aspect of the disclosure provides a method for modifying a virtual object in a virtual environment. The method can include receiving at one or more processors, an identification of the virtual object within the virtual environment. The method can include receiving, from a first user device communicatively coupled to the one or more processors, an annotation including one or more changes to be applied to the virtual object. The method can include determining a type of the one or more changes based on the annotation. The method can include determining a location of the one or more changes to the virtual object based on the annotation. The method can include causing the virtual object to be modified as a modified virtual object using a computer-aided design (CAD) software program to implement the changes indicated in the annotation. The method can include displaying the modified virtual object within the virtual environment.

Another aspect of the disclosure provides a non-transitory computer-readable medium comprising instructions for modifying a virtual object in a virtual environment. When executed by one or more processors, the instructions cause the one or more processors to receive an identification of the virtual object within the virtual environment. The instructions further cause the one or more processors to receive, from a first user device communicatively coupled to the one or more processors, an annotation including one or more changes to be applied to the virtual object. The instructions further cause the one or more processors to determine a type of the one or more changes based on the annotation. The instructions further cause the one or more processors to determine a location of the one or more changes to the virtual object based on the annotation. The instructions further cause the one or more processors to cause the virtual object to be modified as a modified virtual object using a computer-aided design (CAD) software program to implement the changes indicated in the annotation. The instructions further cause the one or more processors to display the modified virtual object within the virtual environment.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a system for adding annotations to virtual objects in a virtual environment;

FIG. 1B is a functional block diagram of user device for use with the system of FIG. 1;

FIG. 2 is a flowchart of an embodiment of a method for annotating on virtual objects;

FIG. 3 is a flowchart of an embodiment of a method for annotating on virtual objects;

FIG. 4A through FIG. 4D are flowcharts of various embodiments of methods for detecting an annotation initiation action by a user;

FIG. 5 is a flowchart of an embodiment of a method for determining if the user is allowed to create an annotation;

FIG. 6 is a flowchart of an embodiment of a method for determining a type of annotation;

FIG. 7A is a flowchart of an embodiment of a method for recording and saving an annotation;

FIG. 7B is a flowchart of another embodiment of a method for recording and saving an annotation;

FIG. 8A is a flowchart of an embodiment of a method for providing an annotation to a user device;

FIG. 8B is a flowchart of an embodiment of a method for presenting the annotation to a user;

FIG. 8C is a flowchart of an embodiment of a method for exporting annotations;

FIG. 9A through FIG. 9I are flowcharts of various embodiments of methods for detecting and capturing a journal entry in a virtual environment;

FIG. 10A through FIG. 10C are flowcharts of various embodiments of methods for detecting, capturing and displaying an annotation;

FIG. 11A is a graphical representation of an embodiment of an annotations;

FIG. 11B is a graphical representation of another embodiment of an annotations;

FIG. 11C is a graphical representation of another embodiment of an annotations;

FIG. 12 is a flowchart of an embodiment of a method for generating smart annotations;

FIG. 13A is a flowchart of an embodiment of a method for creating a modified virtual object using an annotation and the virtual object;

FIG. 13B is a flowchart of another embodiment of a method for creating a modified virtual object using an annotation and the virtual object;

FIG. 13C is a flowchart of another embodiment of a method for creating a modified virtual object using an annotation and the virtual object;

FIG. 14A is a graphical representation of the method for creating a modified virtual object of FIG. 13A;

FIG. 14B is a graphical representation of the method for creating a modified virtual object of FIG. 13B;

FIG. 14C is a graphical representation of the method for creating a modified virtual object of FIG. 13C;

FIG. 14D is a graphical representation of another embodiment of the method of FIG. 14C; and

FIG. 15 is a flowchart of another embodiment of a method for making smart annotations.

### DETAILED DESCRIPTION

In a collaborative environment like a design environment, it is beneficial to have access to images of the object that is being designed. Notes and drawings showing revisions to the object can be added to the images in a manner that often covers the object. New images need to be created to remove the notes. Alternatively, notes like text, audio and video can be provided in separate files that may separate from the images during collaboration, that may not be readily available to participants during the collaborative process, or that may not be easily used by those participants.

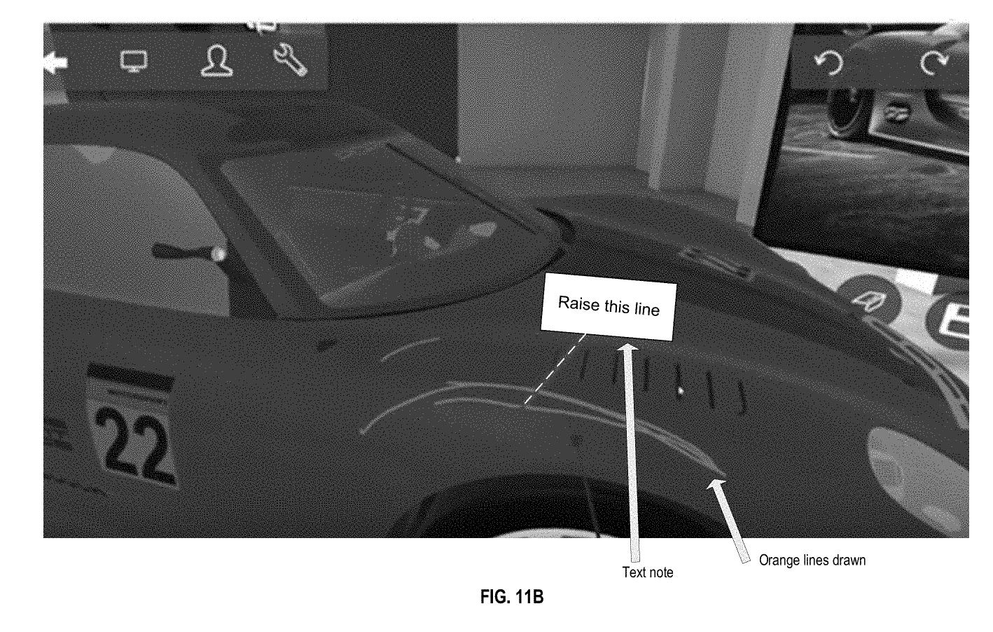

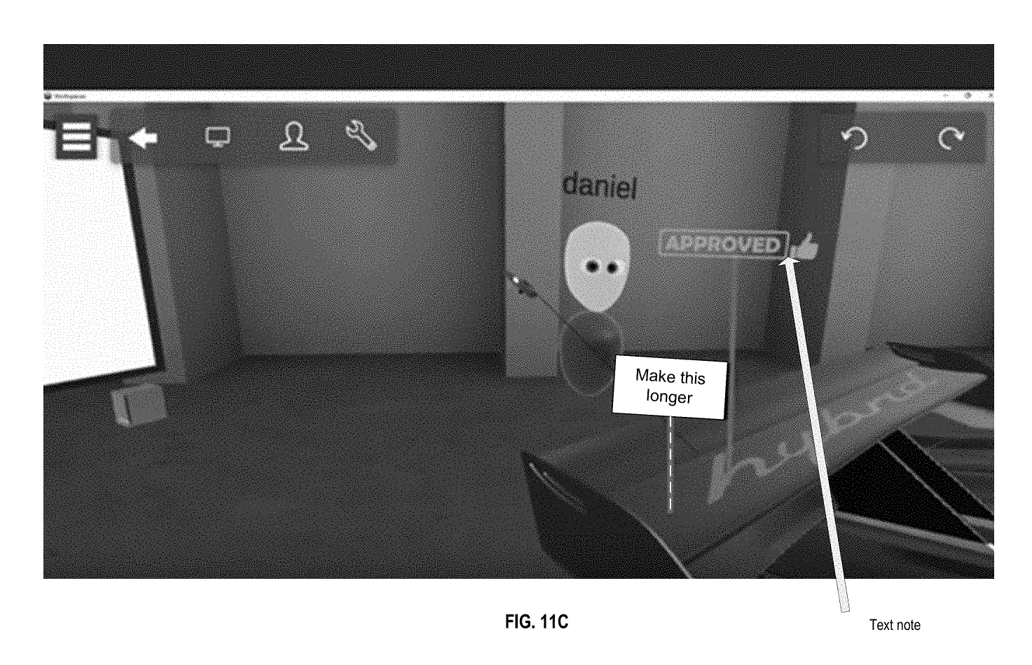

This disclosure relates to different virtual collaborative environments for adding annotations (also referred to as “notations”) to multi-dimensional virtual objects. Such annotations can include text, recorded audio, recorded video, an image, a handwritten note, a drawing, a document (e.g., PDF, Word, other), movement by the virtual object, a texture or color mapping, an emoji, an emblem and other items. Once added, the annotations can be hidden from view, and later be displayed in view again. By way of example, FIG. 11A through FIG. 11C depict screen shots showing different annotations appended to a virtual object.

In some embodiments, when a user wants to add an annotation to a virtual object, the user directs the tool (e.g., handheld controller, finger, eye gaze, or similar means) to intersect with the virtual object, the intersection is detected, and the user is provided a menu to draw or attach. The menu options may be programmable into a controller, or provided a virtual menu that appears when the intersection occurs.

If the user selects the option to draw, intersecting positions of the tool with parts of the virtual object over time are recorded as a handwritten drawing until annotational drawing is no longer desired (e.g., the user selects an option to stop drawing, or directs the tool away from the virtual object so it no longer intersects the virtual object). If the user is drawing on the virtual object, the movement is captured, a visual representation of the movement is provided in a selected color to different users, and the drawing is recorded for later viewing with the virtual object. For example, if the user draws a line, the movement of the user's hand or drawing tool is captured, and a line displays on the virtual object where the tool intersected with the virtual object. A user may also have the option to draw shapes on the virtual object (e.g., squares, circles, triangles, arcs, arrows, and other shapes).

If the user selects the option to attach an item, the user is provided with subsequent options to attach an audio, video, picture, text, document or other type of item to attach. By way of example, the user can record a message, use speech to text to create a text annotation, attach a previously captured video or document, or perform another action and attach it to the virtual object at the point where the tool intersected the virtual object.

In some embodiments, the item of an annotation can be first selected and then dragged and dropped to a point of the virtual object (e.g., where the tool intersects the virtual object). In this scenario, user selection of the item is detected, and a point of the virtual object that intersects with the item after the user moves and releases the item is determined and recorded as the location of the annotation that contains the item. If the item is released at a point that is not on the virtual object, then the item may return to its previous position before it was moved.

Intersections may be shown to the user by highlighting the points of intersection, which enables the user to better understand when an intersection has occurred so the user can create an annotation. Different variations of what constitutes an intersection are contemplated. In one example of intersection, the tool intersects the virtual object when a point in a virtual environment is co-occupied by part of the tool and by part of the virtual object. In another example of intersection, the tool intersects the virtual object when a point in a virtual environment occupied by part of the tool is within a threshold distance from a point in a virtual environment occupied by part of the virtual object. The threshold distance can be set to any value, but is preferably set to a small enough value so the locations of annotations appended to a virtual object appear on the virtual object when viewed from different angles in the virtual environment.

Users may also undo any annotation (e.g., attachment or drawing) on a virtual object. Users may also create a local copy of an annotation before the annotation is exported elsewhere for permanent storage or later display to any user viewing the virtual object.

In some embodiments, restrictions are placed on whether a user can create a type of annotation based on the type of virtual object (e.g., whether the virtual object supports drawing on its surface, or movement), the type of user (e.g., whether the user is authorized to create an annotation), the type of user device (e.g., whether user inputs are available to create the type of annotation), the type of dimensional depiction of the virtual object (e.g., drawing is not available when a three-dimensional virtual object is displayed to a user in two-dimensions), a type of connection (e.g., where a slow or limited connection does not allow a user to make certain annotations that require data transfer in excess of what is supported by the connection), or other types of conditions.

In some embodiments, restrictions are placed on whether a user can view or listen to a type of annotation based on the type of user (e.g., whether the user is authorized to view or listen to an annotation), the type of user device (e.g., whether user device outputs are available to provide the type of annotation), the type of dimensional depiction of the virtual object (e.g., whether annotations on three-dimensional virtual objects can be displayed to a user in two-dimensions), a type of connection (e.g., where a slow or limited connection does not allow a user to view or listen to certain annotations that require data transfer in excess of what is supported by the connection), or other types of conditions.

In some implementations of embodiments described herein, each annotation later appears at the points of the virtual object where the annotation was placed (e.g., where a tool intersected with the virtual object) even if the position or orientation of the virtual object changes in a virtual environment, or if the virtual object is viewed from another pose (position and orientation) of a user in the virtual environment. In some embodiments, the annotation scales with scaling of the virtual object.

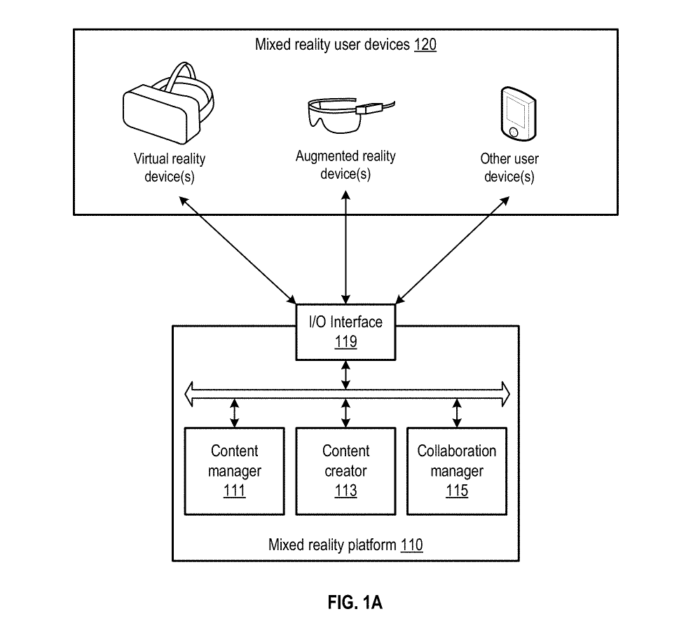

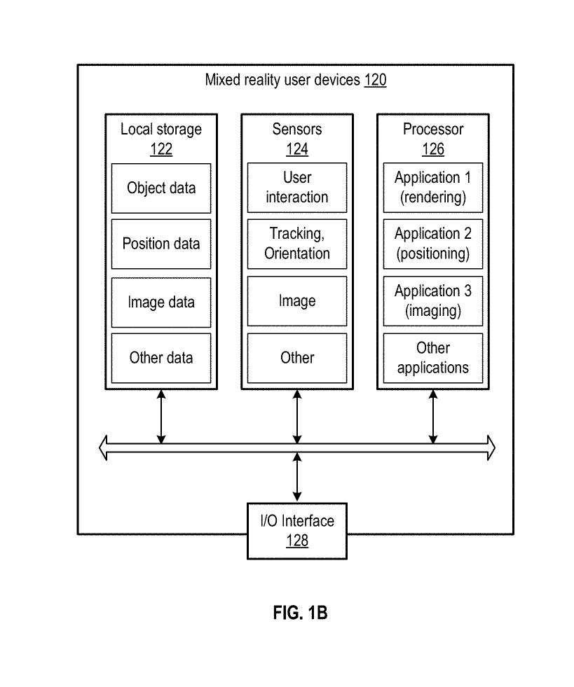

FIG. 1A is a functional block diagram of an embodiment of a system for adding annotations to virtual objects in a virtual environment. A system for creating computer-generated virtual environments and providing the virtual environments as an immersive experience for VR, AR and/or MR users is shown in FIG. 1A. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 111. The content manager 113 stores content created by the content creator 111, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120.

FIG. 1B is a functional block diagram of user device for use with the system of FIG. 1. Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

### Adding Annotations to Virtual Objects in a Virtual Environment

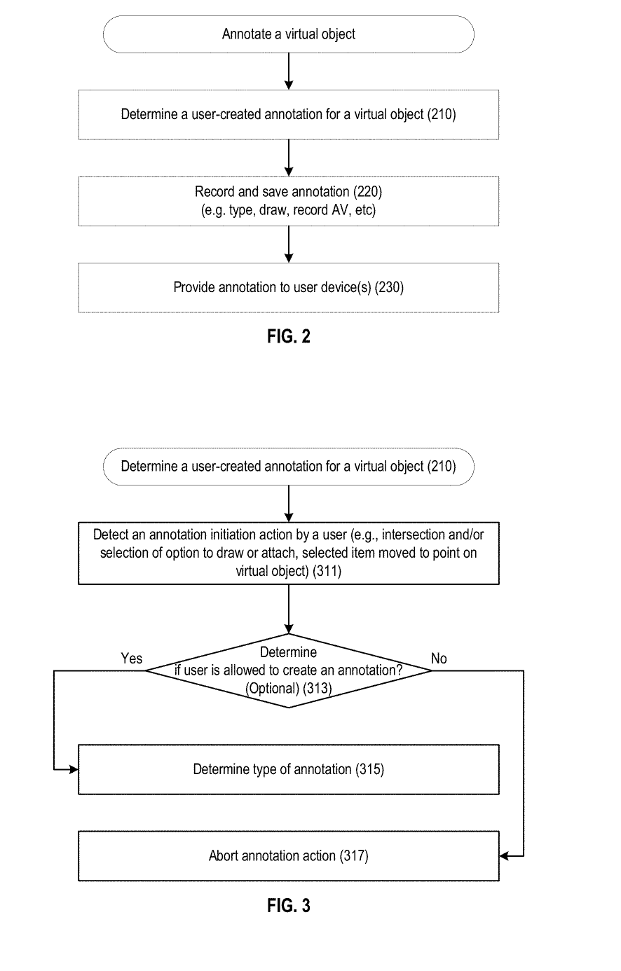

FIG. 2 is a flowchart of an embodiment of a method for annotating on virtual objects. The method shown in FIG. 2 further includes providing the annotations to user devices for display or playback. The process starts by determining that a user has initiated an action to create an annotation on a virtual object (210). Once the annotation has been created, the annotation is recorded and saved in as part of a virtual object (220). Alternatively, the annotation may be saved separate from the virtual object, but with an association to a point or points on the virtual object (e.g., points of intersection when the annotation was made)—e.g., an association like identifier(s) of the point(s). Next, the annotation is shared with other users (230).

In some embodiments, providing an indication of the originator/author of the annotation allows other users to access or otherwise view the annotation. In addition, the originator of the annotation can define access restrictions which identify who is allowed to view the annotations. In some cases, only be the originator may be able to view the annotations. In other cases, multiple users can be present in the virtual environment but only a selected portion of the multiple users (e.g., a white list) may view the specified annotations.

FIG. 3 is a flowchart of an embodiment of a method for annotating on virtual objects. By way of example, the method of FIG. 3 depicts a process for determining a user-created annotation for a virtual object during step 210 of FIG. 2. An annotation initiation action by a user is detected (311). Examples of annotation initiation actions include moving a tool to intersect a virtual object and/or selecting an option to draw or attach an annotation item, or selecting an annotation item and moving it to a point on virtual object. Known approaches may be used to detect these actions. Optionally, the process may determine if the user is allowed to create an annotation (313)—e.g., based on permissions or other conditions. In other embodiments of step 210, this determination may occur before step 311, after other steps in FIG. 3, or at any time before, during, and after the creation of an annotation. If the user is allowed to create an annotation, the type of annotation being created is determined (315). Otherwise, if the user is not allowed to create an annotation, the system will abort the annotation action (317). In some embodiments, step 315 is carried out before step 313.

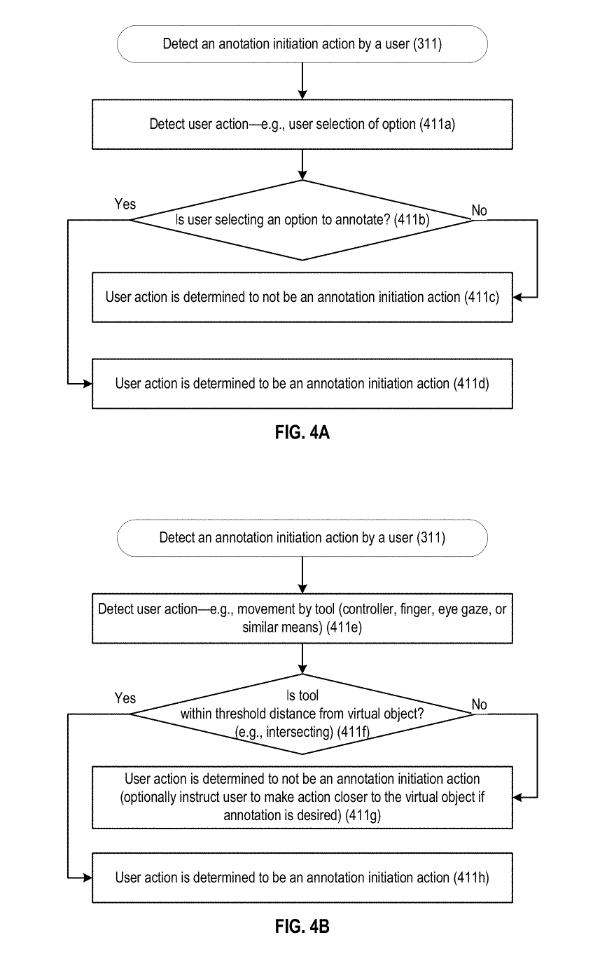

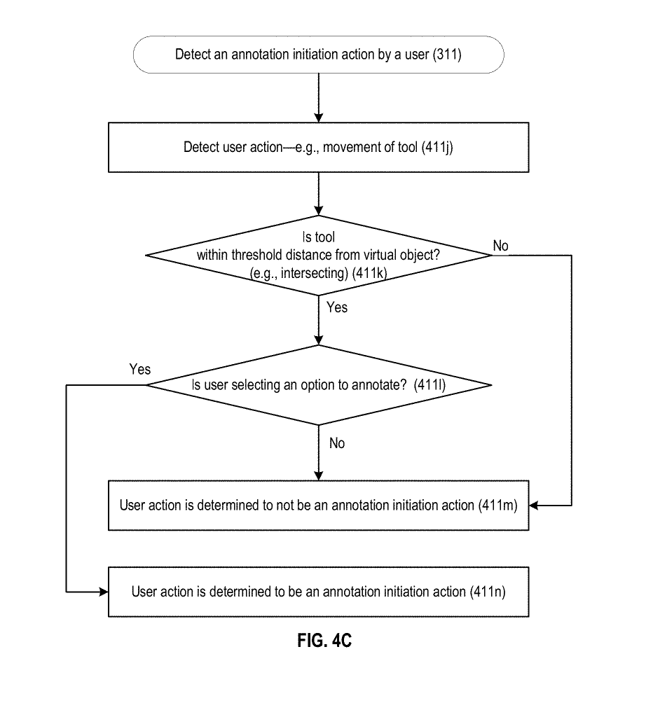

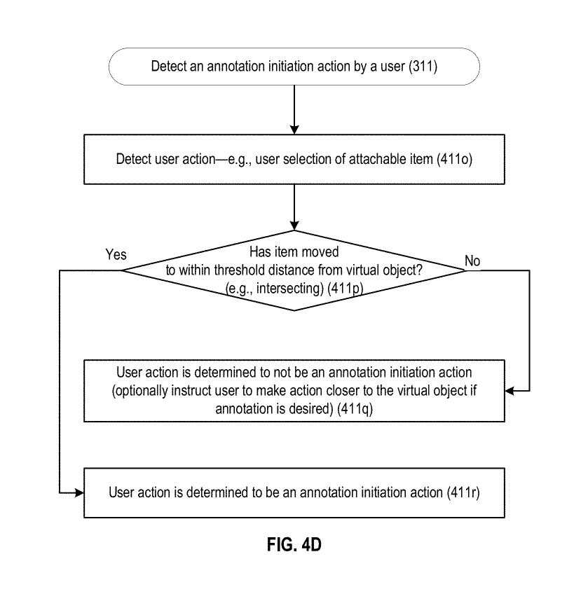

FIG. 4A through FIG. 4D are flowcharts of various embodiments of methods for detecting an annotation initiation action by a user. Each of the described methods depicts a different embodiments of a process for detecting an annotation initiation action by a user during step 311 of FIG. 3.

In FIG. 4A, a user action is detected (411a)—e.g. user selection of an option. A determination is made as to whether the user is selecting an option to annotate (411b). If the user is not selecting an option to annotate, the user action is determined to not be an annotation initiation action (411c). If the user is selecting an option to annotate, the user action is determined to be an annotation initiation action (411d).

In FIG. 4B, a user action is detected (411e)—e.g. movement by tool (controller, finger, eye gaze, an avatar representing the user, or similar means). A determination is made as to whether the tool is within a threshold distance from a virtual object (e.g., intersecting with the virtual object or within a preset maximum distance from the virtual object like a defined number of pixels) (411f). If the tool is not within the threshold distance, the user action is determined to not be an annotation initiation action (411g). An optional instruction may be generated to instruct the user to move the tool closer to the virtual object if an annotation is desired. If the tool is within the threshold distance, the user action is determined to be an annotation initiation action (411h). Different threshold distances between a point in the virtual environment occupied by the tool and a point in the virtual environment occupied by the virtual object can be used. One example includes a straight linear distance between the points, a vector distance from one of the points to the other point, or other threshold determinations where the location of the tool is measured relative to the location of the virtual object or other representation of the virtual object's location.

In FIG. 4C, a user action is detected (411j)—e.g. movement by tool. A determination is made as to whether the tool is within a threshold distance from a virtual object (411k). If the tool is not within the threshold distance, the user action is determined to not be an annotation initiation action (411m). If the tool is within the threshold distance, a determination is made as to whether the user is selecting an option to annotate (411l). If the user is not selecting an option to annotate, the user action is determined to not be an annotation initiation action (411m). If the user is selecting an option to annotate, the user action is determined to be an annotation initiation action (411n).

In FIG. 4D, a user action is detected (411o)—e.g. user selection of attachable item. A determination is made as to whether the selected item has moved to within a threshold distance from a virtual object (e.g., intersecting with the virtual object after the user moves the item from the location at which the item was selected) (411p). If the item is not within the threshold distance, the user action is determined to not be an annotation initiation action (411q). An optional instruction may be generated to instruct the user to move the item closer to the virtual object if an annotation is desired. If the item is within the threshold distance, the user action is determined to be an annotation initiation action (411r).

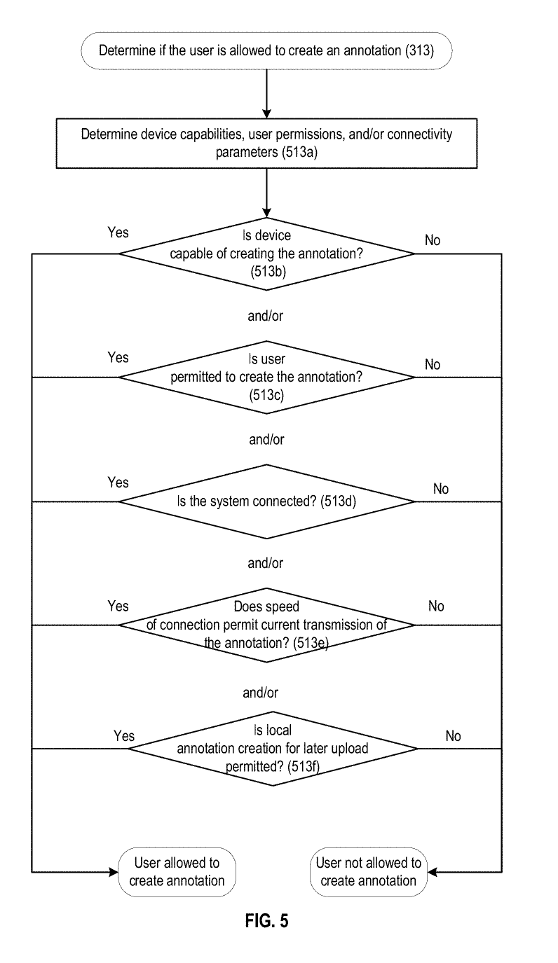

FIG. 5 is a flowchart of an embodiment of a method for determining if the user is allowed to create an annotation The described method can occur during step 313 of FIG. 3. As shown in FIG. 5, one or more different conditions are determined (513a)—e.g., user device capabilities, user permissions, connectivity parameters, and/or other conditions. By way of example, any individual condition or combination of the following conditions can be selected for testing: if the user device operated by the user is capable of creating an annotation (513b), if the user is permitted to create an annotation (513c), if the user device is connected to the Internet (513d), if the speed of the user device's connection permits the annotation to be transmitted or is of reasonable throughput capability to deliver the annotation over the network in a reasonable time (513e), and/or if local annotation creation for later transmission is permitted (513f). If the results of the selected test(s) are affirmative, the user is allowed to create the annotation. If the results of the selected test(s) are negative, the user is not allowed to create an annotation.

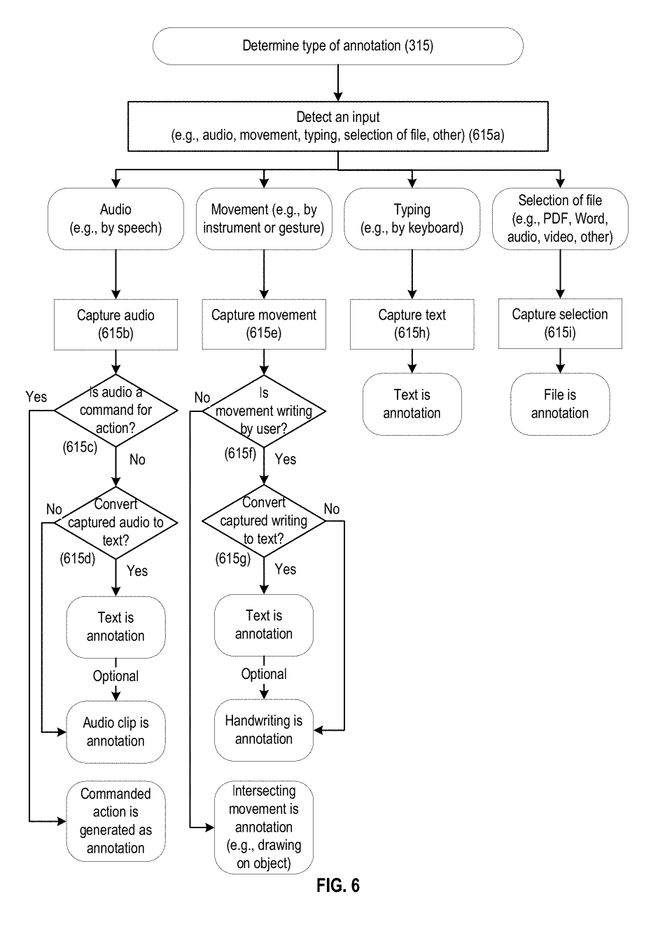

FIG. 6 is a flowchart of an embodiment of a method for determining a type of annotation. The processes described in connection with FIG. 6 can occur during step 315 of FIG. 3, for example. As shown in FIG. 6, a user input is detected (615a), which may include detected audio, movement of a tool, typing, selection of a file, or another recognizable input.

If audio (e.g., user speech) is detected, the audio is captured (615b). A determination is made as to whether the audio is a command for action (615c). If the audio is a command for action, the commanded action is generated as the annotation. As examples, the command for action could be an instruction to do something—e.g., “rotate three times” or “change color”—and the commanded action—e.g. the three rotations, the change of color—would be stored as the annotation to be carried out when the annotation is viewed or displayed. If the audio is not a command for action (e.g., is a note), a determination is made as to whether the audio is to be converted to text (615d). Any resulting text conversion is the annotation. The audio itself may be an audio clip and treated as the annotation.

If movement (e.g., by a tool) is detected, the movement is captured (615e). A determination is made as to whether the movement (e.g., intersecting with the virtual object) is a handwritten note or a drawing (615f). If the movement is a drawing, the movement is the annotation. If the movement is a handwritten note, a determination is made as to whether the handwriting is to be converted to text (615g). Any resulting text conversion is the annotation. The writing itself may be treated as the annotation. Optionally, movement may be saved as an image file, a video file (e.g. a visual playout of the movement) or other type of file consistent with the movement (e.g., a CAD file). In some embodiments, the movement may be captured as geometry data that represents a 3-D version of the annotation.

If typing is detected, the typed text is captured (615h) and treated as the annotation. By way of example, typing may be by a physical or virtual keyboard, by verbal indication of the letters, or other forms of typing. Any typed text can optionally be converted to spoken text, which is used as the annotation.

If selection of a file is detected, the selected file is captured (615i) and treated as the annotation. Examples of files include documents (e.g., PDF, Word, other), audio files, video files, image files, and other types of files.

Each vertical sub-flow under step 615a need not be performed in each embodiment of FIG. 6. Also each step in a particular vertical sub-flow need not be performed in each embodiment of FIG. 6.

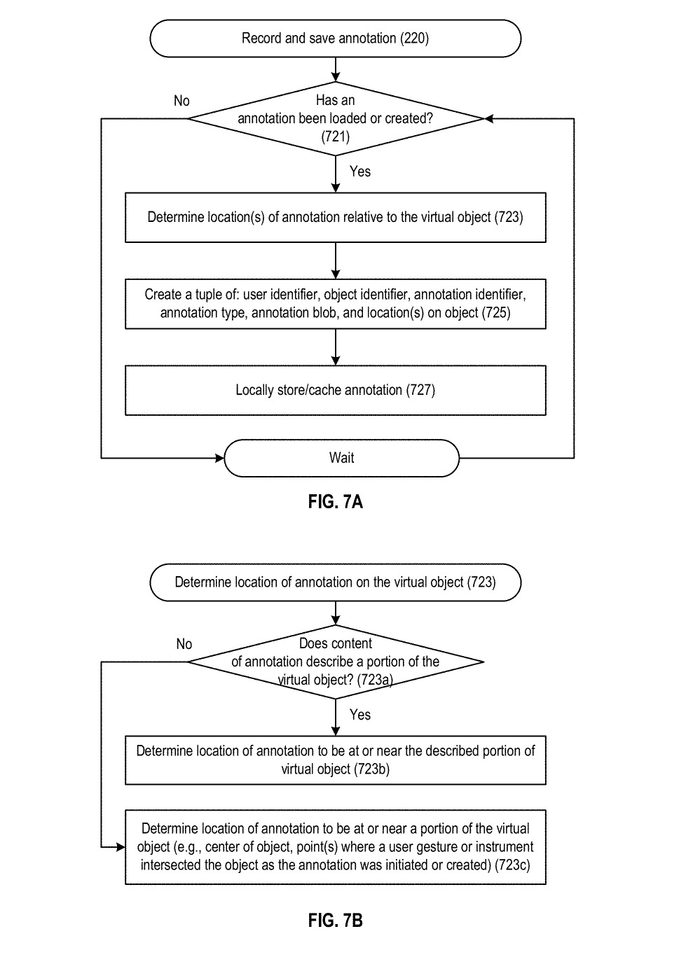

FIG. 7A and FIG. 7B are flowcharts of embodiments of a method for recording and saving an annotation. In FIG. 7A, a determination is made as to whether the annotation has been loaded or created (721). If the annotation has not been created or loaded, the process waits until creation or loading is complete. If the annotation has been created or loaded, the location(s) of the annotation are determined (723)—e.g., locations relative to points of a virtual object at which the annotation has been made. By way of example, the location(s) may include the location of the intersection from steps 411e-f of FIG. 4B, or another point designated by the user where the user provides an input designating the location via speech, text, selection or other input. A tuple is created (725), which may include the following of data: user ID, object ID, annotation ID, annotation type, annotation blob, and location on object or location in virtual environment. An annotation blob is a set of data that represents the annotation. Finally, the location(s) and/or tuple of data can be locally stored or cached (727)—e.g., on the user device. In some other embodiments, the data can be stored externally or remotely, such as in the cloud or at a remote server.

The process of FIG. 7B describes how the location of an annotation on a virtual object is optionally determined during step 723. A determination is made as to whether content of the annotation describes a portion of the virtual object (723a). If content of the annotation describes a portion of the virtual object, the location of the annotation is determined to be at or near the described portion of the virtual object (723b). If content of the annotation does not describe a portion of the virtual object, the location of the annotation is determined to be at or near a predefined portion of the virtual object (723c)—e.g., center of a surface of the virtual object, point(s) where a tool intersected the virtual object as the annotation was initiated, a pre-designated portion of the virtual object, or another location. An example of content that describes a portion of the virtual object includes audio or text that identifies the portion of the virtual object—e.g., if the annotation content is “the roof of this car should be painted blue”, then a location of the annotation when the virtual car is displayed is determined to be a point on or near the roof of the virtual car.

Any location of an annotation may be highlighted to indicate that an annotation is available for selection and/or activation at that location.

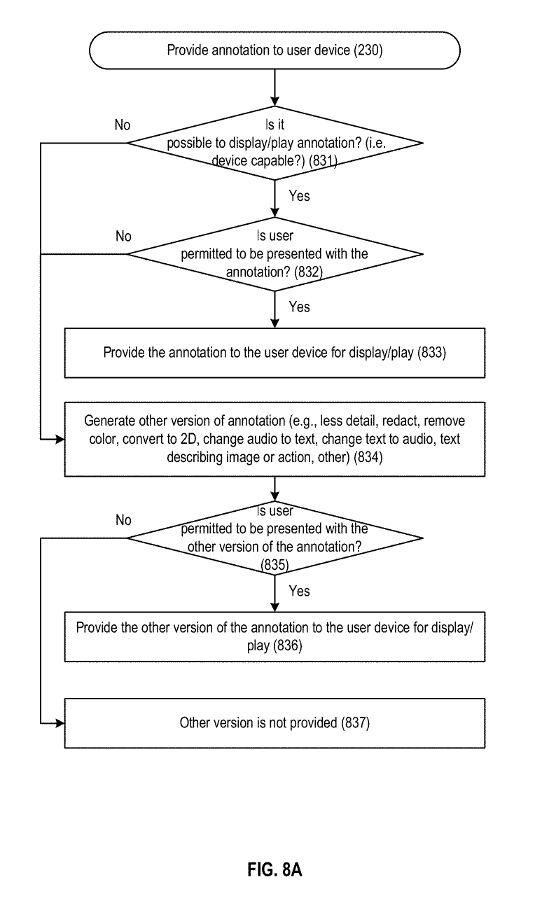

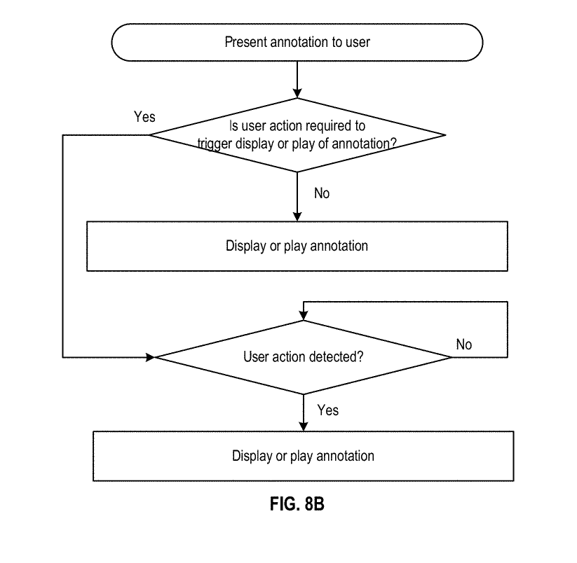

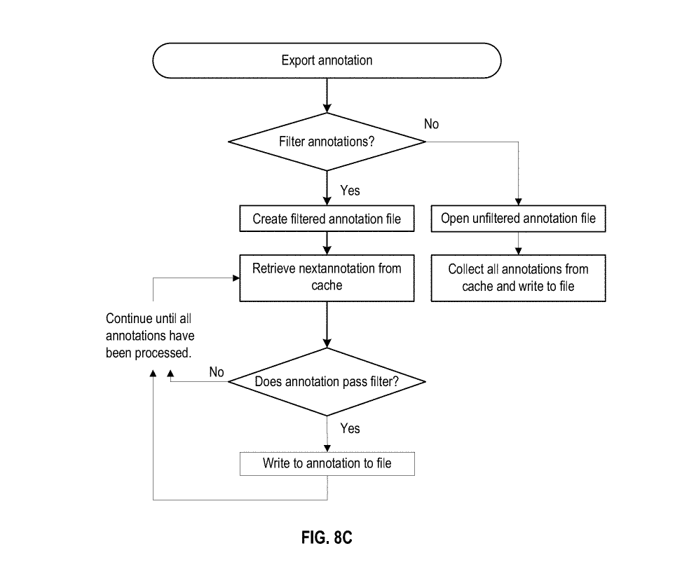

FIG. 8A through FIG. 8C depict processes for providing an annotation to a user device during step 230, when rendering an annotation, and when exporting an annotation.

FIG. 8A is a flowchart of an embodiment of a method for providing an annotation to a user device. As shown in FIG. 8A, a determination is made as to whether it is possible to present (e.g., display/play) the original version of the annotation using a particular user device (831). In some embodiments, the platform 110 can verify the user has permission to access the annotation. For example, the originator or author of the annotation can designate the annotation as “hidden,” and control access by other users (e.g., user devices) to the annotation. In addition, the user who creates the annotation can further create a white list of users that are allowed to access the annotation. If it is possible to present the original version of the annotation using a particular user device, a determination is made as to whether the user is permitted to be presented with (e.g., to see/experience) the original version of the annotation (832). If the user is permitted to be presented with the original version of the annotation, the original version is provided to the user device of the user (833). If the user is not permitted to be presented with the original version of the annotation, the process proceeds to step 834. If it is not possible to present the original version of the annotation using a particular user device, or if the user is not permitted to be presented with the original version of the annotation, a different version of the annotation may be generated (834).

By way of example, the different version may include less detail, redacted portions of the annotation, removed color/texture, fewer or no animations, a two-dimensional representation of a three-dimensional annotation, transcription of audio to text or vice versa, replacement of a visual depiction or action with a written description of the visual depiction or action, or another form. A determination is made as to whether the user is permitted to be presented with the different version of the annotation (835). If the user is permitted to be presented with the different version of the annotation, the different version is provided to the user device of the user (836). If the user is not permitted to be presented with the different version of the annotation, the different version is not provided to the user device of the user (837). Step 834 through step 837 may be repeated for different versions until a version that the device can render, and that the user is permitted to be presented with, is generated (if possible). It should also be appreciated that, in some embodiments, the negative results from steps 831 and 832 may proceed directly to a step of not providing any version (not shown).

FIG. 8B illustrates how an annotation is presented to a user. As shown, a determination is made as to whether user action to trigger presentation (e.g., display and/or play) of the annotation is required. If a user action is not required, the annotation is automatically presented. If a user action is required, the annotation is presented only after user action is detected. User action may be required if: (i) the natural form of the annotation is bigger than the user's viewing area or a display region for an annotation, (ii) the annotation is of a type that may be disruptive or unwanted by the user (e.g., an audio or video file playing at an inopportune time, or the size/scope of the annotation overlaid in front of the virtual object would disrupt the user's view of the virtual object), or (iii) the current position of the virtual object or visual perspective of the virtual object does not allow for the presentation of the annotation in the current viewing area for the user (e.g., a text annotation on the roof of a car when the perspective of the virtual car doesn't show the roof). In some embodiments when the current position of the virtual object or visual perspective of the virtual object does not allow for the presentation of the annotation in the current viewing area for the user, the annotation may be presented in a way so it can be seen by the user (e.g., displayed at a different location than the stored relative location of the annotation to the virtual object, converted to a different form like text converted to audio, or illustrated with or by an icon, (e.g. “!”) to indicate additional information is present). User actions to trigger presenting the annotation may include one or more of the following: a verbal command, a tool intersection with the virtual object or tool intersection with the visual depiction of the annotation, eye/gaze detection directed towards the virtual object or the annotation, a custom button/input that is triggered, moving closer to the object, or others.

FIG. 8C illustrates how annotations are exported to a user. A determination is made as to whether existing annotations are to be filtered. By way of example, filters may be based on user id, object id, object type, annotation type, or other stored types of data. If existing annotations are not to be filtered, an unfiltered annotation file is opened, and all annotations from cache, for example, are collected and written to the unfiltered annotation file. If existing annotations are to be filtered, a filtered annotation file is opened, individual annotations from cache are retrieved, and retrieved annotations that pass the filter are written to the filtered annotation file. The exemplary cache can represent one or more memory unit (e.g., memories) within the user device 120 or at the platform 110.

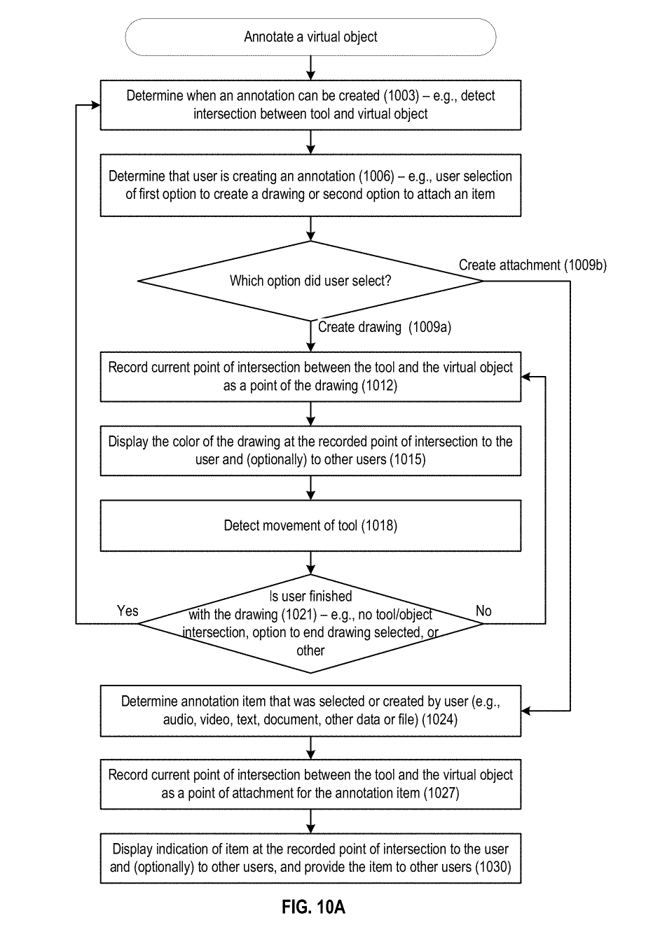

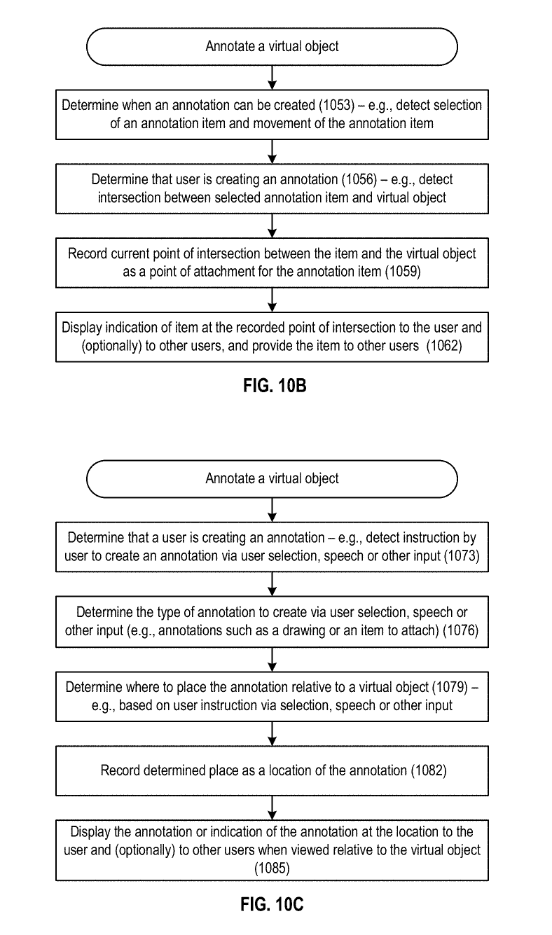

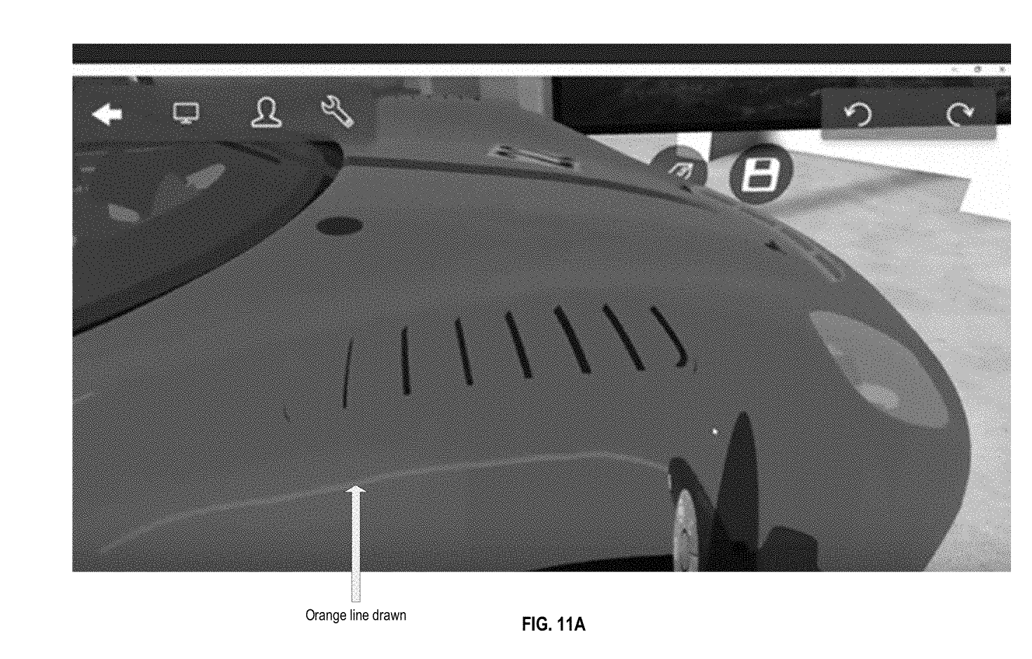

FIG. 10A through FIG. 10C depict different methods for detecting, capturing and displaying an annotation.

As shown in FIG. 10A, a determination is made as to when an annotation can be created (1003)—e.g., by detecting an intersection between tool and virtual object. A determination is then made that a user is creating an annotation (1006)—e.g., by detecting user selection of a first option to create a drawing, or a second option to attach an item.

When the user selection is to create a drawing (1009a), the current point of intersection between the tool and the virtual object is recorded as a point of the drawing (1012), the color of the drawing is displayed at the recorded point of intersection to the user and (optionally) to other users any later times (1015), and a determination is made as to whether the user is finished with the drawing (1021)—e.g., no tool/object intersection, option to end drawing selected by user, or other. If the user is finished with the drawing, the process returns to step 1003. If the user is not finished with the drawing, the process returns to step 1012.

When the user selection is to attach an annotation item (1009b), a selected or created annotation item is determined (1024)—e.g., selection or creation of an audio, video, text, document, other file. The current point of intersection between the tool and the virtual object is recorded as a point of attachment for the annotation item relative to the virtual object (1027). An indication of the annotation item or the annotation item itself is displayed at the recorded point of intersection to the user and (optionally) to other users at a later time, and the annotation item is made available to the other users if not already presented (1030).

As shown in FIG. 1013, a determination is made as to when an annotation can be created (1053)—e.g., by detecting selection of an annotation item. A determination is then made that a user is creating an annotation (1056)—e.g., by detecting intersection between the selected annotation item and the virtual object. The current point of intersection of the annotation item and the virtual object is recorded as a point of attachment for the annotation item (1059). An indication of the annotation item or the annotation item itself is displayed at the recorded point of intersection to the user and (optionally) to other users at a later time, and the annotation item is made available to the other users if not already presented (1062).

As shown in FIG. 10C, a determination is made that a user is creating an annotation (1073)—e.g., by detecting an instruction by the user to create an annotation via user selection, speech or other input from the user. The type of annotation to create is determined via user selection, speech or other input by the user (1076). Examples of types of annotations include a drawing or an item to attach. A determination is made as to where to place the annotation relative to a virtual object (1079)—e.g., based on user instruction via selection, speech or other input by the user. The determined place is recorded as a location of the annotation (1082), and the annotation or indication of the annotation is displayed at the location to the user and (optionally) to other users when viewed relative to the virtual object (1085).

### Generating Smart Annotations

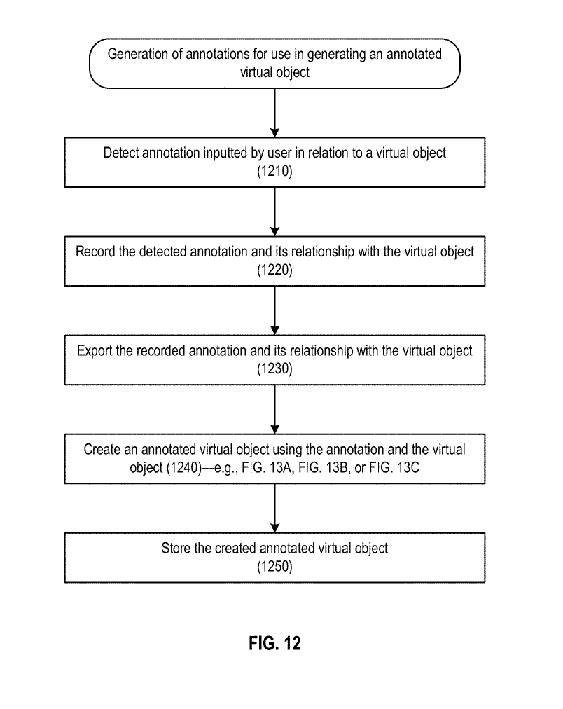

FIG. 12 is a flowchart of an embodiment of a method for generating smart annotations. A process for generating smart annotations for use in generating an modified virtual object based on the annotation(s) is shown in FIG. 12. As shown in FIG. 12, an annotation inputted by a user in relation to a virtual object is detected (1210). The detected annotation and its relationship with the virtual object are recorded (1220) (e.g., using the processes for recording an annotation described elsewhere herein). The recorded annotation and its relationship with the virtual object are exported (1230) (e.g., using the processes for exporting an annotation described elsewhere herein). An modified virtual object is created using the annotation or the contents of the annotation and the virtual object (1240). Finally, the created modified virtual object is stored and may be later presented to one or more users (1250). In some embodiments, presentation can be limited or otherwise depend on permission received by the author or creator of the annotation.

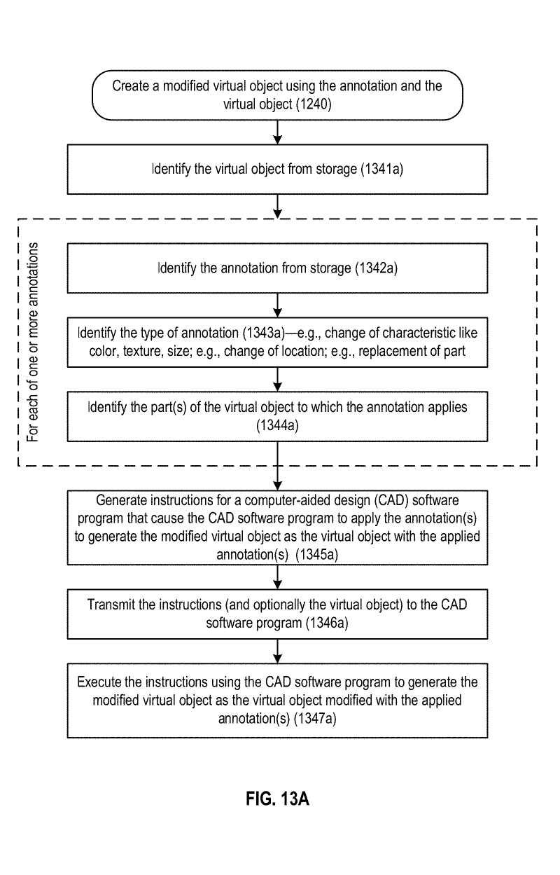

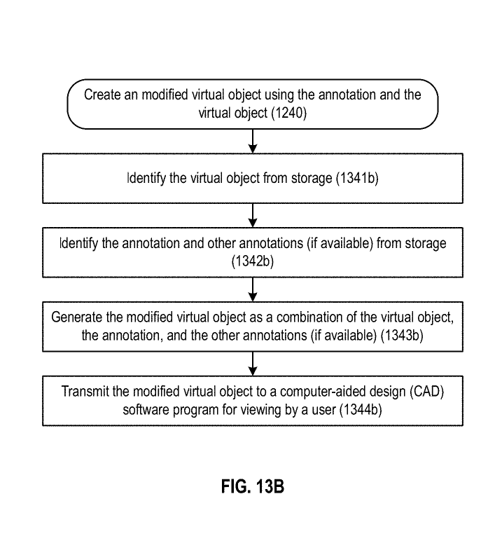

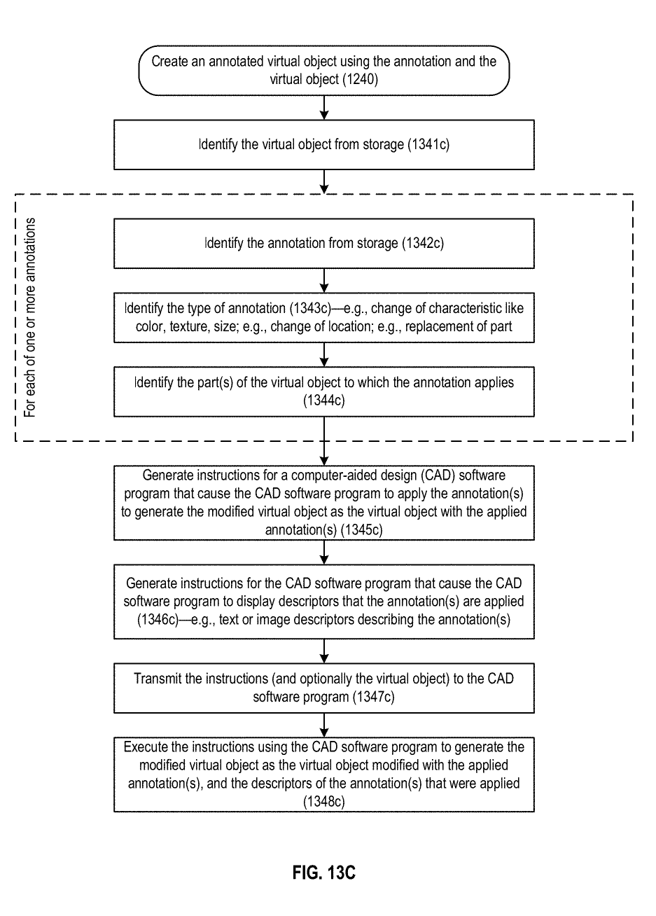

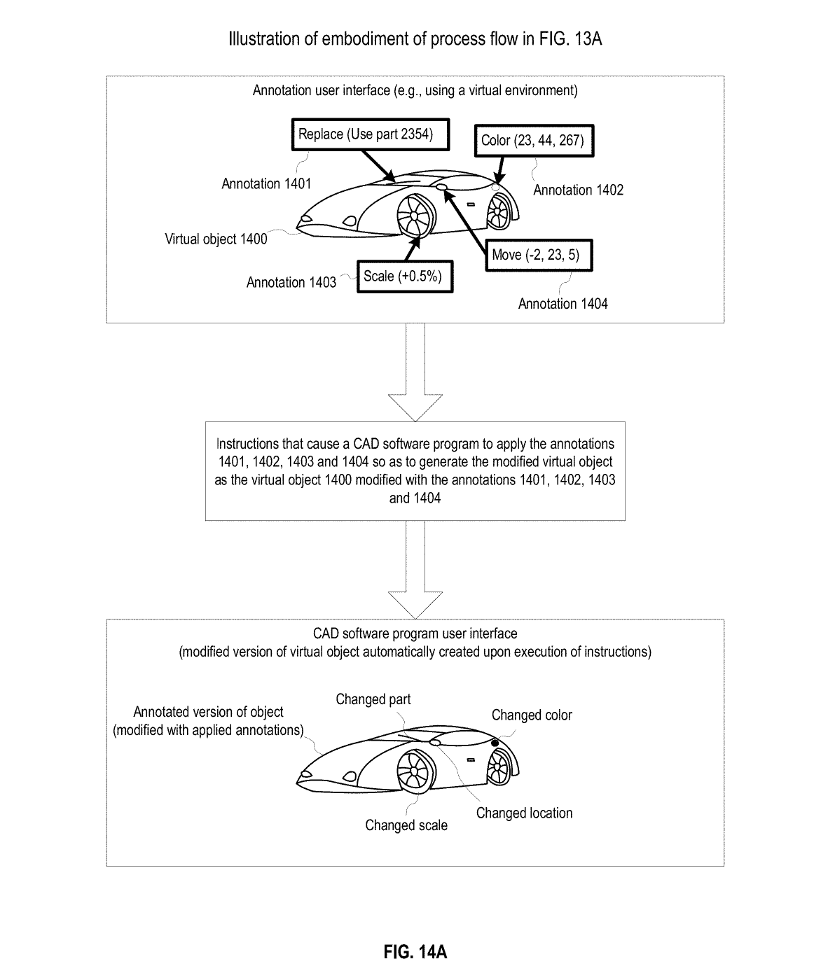

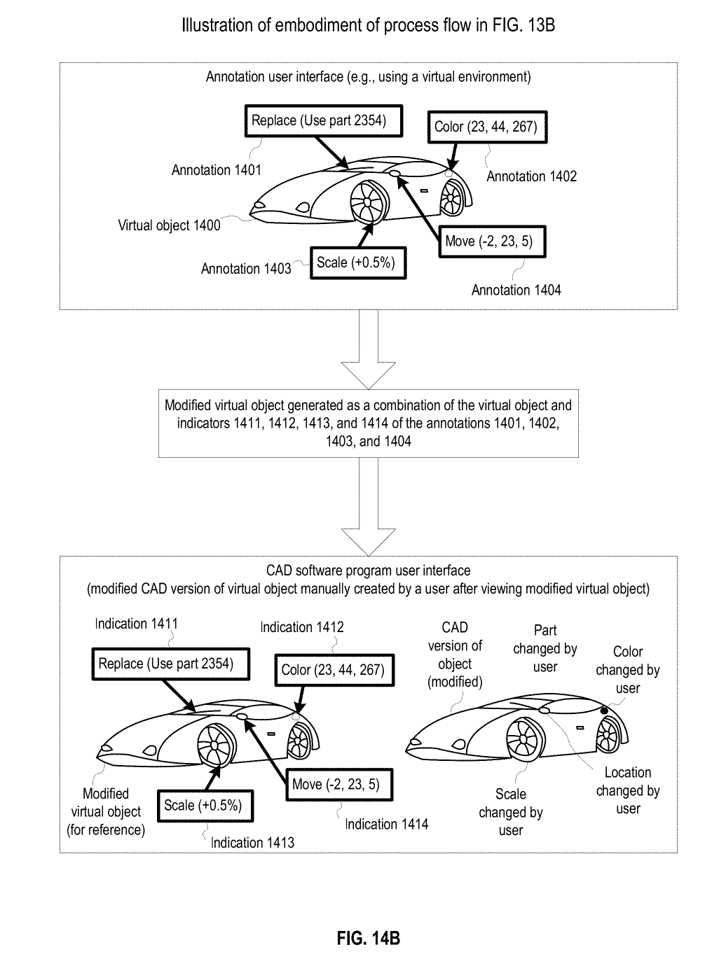

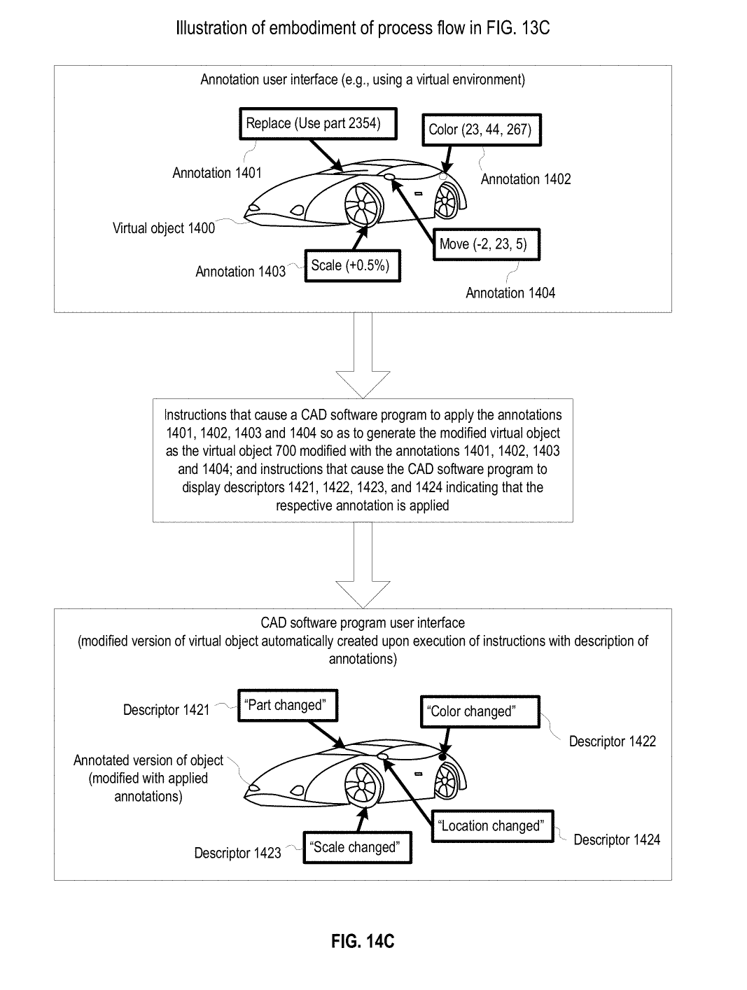

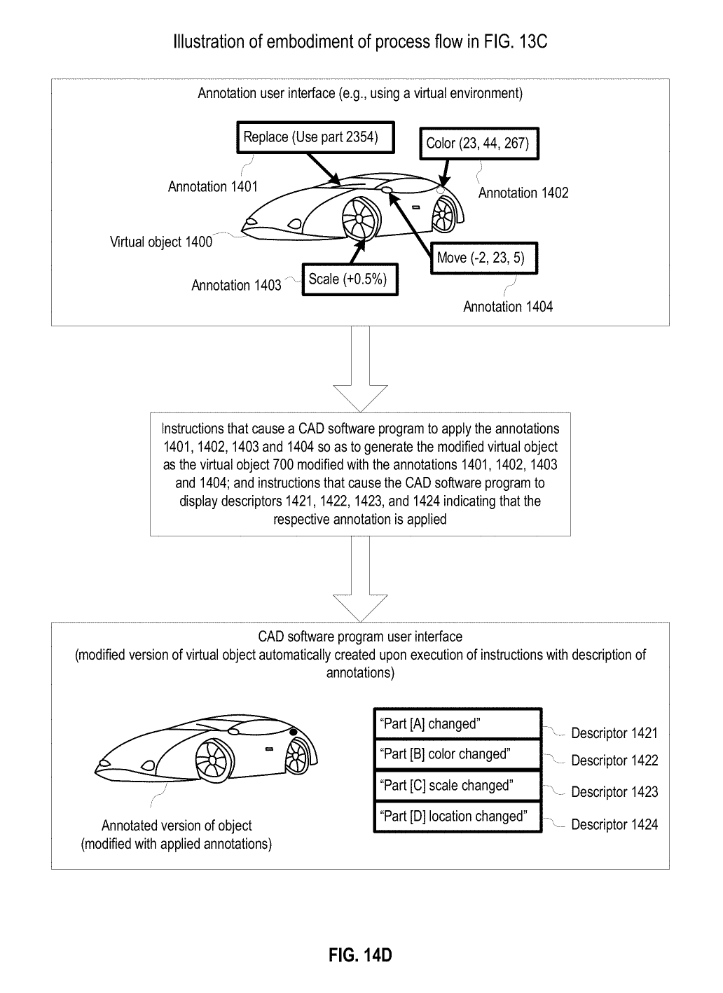

Processes for creating an modified virtual object using an annotation and the virtual object during step 1240 are shown in FIG. 13A, FIG. 13B and FIG. 13C. Illustrations of embodiments of FIG. 13A, FIG. 13B and FIG. 13C are respectively shown in FIG. 14A, FIG. 14B, and FIG. 14C.

FIG. 13A is a flowchart of an embodiment of a method for creating a modified virtual object using an annotation and the virtual object. As shown in FIG. 13A, the virtual object is identified from storage (1341a). For each of one or more annotations, the following steps 1342a through 1344a are carried out. The annotation is identified from storage (1342a). The type of annotation is identified (1343a) Example types of annotations include changing a characteristic (e.g., color, texture, size) of a part of the virtual object, changing the location of a part of the virtual object, replacing a part of the virtual object with another part. The part(s) of the virtual object to which the annotation applies are identified (1344a). Instructions are generated for a computer-aided design (CAD) software program, where the instructions cause the CAD software program to apply the annotation(s) or the actions contemplated by the annotations to generate the modified virtual object as the virtual object with the applied annotation(s) (1345a). In some embodiments, application of the annotations may be automatic. In some embodiments, application of the annotations may be performed in response to instructions received via the user device 120. The instructions (and optionally the virtual object) are transmitted to the CAD software program (1346a). The instructions are executed using the CAD software program to generate the modified virtual object as the virtual object modified with the applied annotation(s) (1347a). By way of example, the generated instructions may be a code script that is compatible with and recognized by the CAD software program, and that instructs the CAD software program to modify the virtual object (or a version thereof) with the designated annotation. The format of the script may depend on the specifications of the CAD software program. In some embodiments, the script can be human-readable scripting language or based on the target CAD software (e.g., the software that will automatically apply the annotation).

FIG. 14A is a graphical representation of the method for creating a modified virtual object of FIG. 13A. As shown in FIG. 14A, an annotation user interface (e.g., provided in a virtual environment) enables a user to apply different annotations 1401 through 1404 to a virtual object 1400. The annotations can be different things, including, for example, (i) an annotation note 1401 to replace a particular part of the virtual object 1400 along with an arrow drawn to the particular part, a designation of the particular part to be replaced, and/or a designation of another part to be used in place of the particular part, the annotation could be directly attached to the part that needs changing or specify the part number or part ID in the annotation; (ii) an annotation note 1402 to change the color of a part of the virtual object 1400 along with an arrow drawn to the part to modify with the new color, a designation of the part to be modified, and/or a designation of the new color; (iii) an annotation note 1403 to change the scale or dimensions of a part of the virtual object 1400 along with an arrow drawn to the part to be altered, a designation of the part to be altered, and/or a designation of the scaling factor or dimension change to be made to the part; (iv) an annotation note 1404 to move a part of the virtual object 1400 along with an arrow drawn to the part to be moved, a designation of the part to be moved, and/or a designation of the amount of movement or destination of the part after the movement is made; and/or (v) any other annotation (e.g., drawing, attachment, or other annotation describe herein). After annotations are defined by a user in the annotation user interface, a processor (e.g., the platform 110) generates instructions that cause a CAD software program to apply the annotations 701, 702, 703 and 704 so as to generate the modified virtual object as the virtual object 700 with the annotations 701, 702, 703 and 704 applied. In some embodiments, the instructions can be automatically applied by the CAD software, or can be manually applied by a user or can be auto applied after review/acceptance by a user. The generated instructions are provided to the CAD software program, which executes the instructions to generate the modified virtual object or the resulting virtual object. The resulting virtual object or updated virtual object refers to the changed version of the virtual object after the annotation instructions have been applied. As shown, the modified, or changed virtual object includes the other part, the new color, the changed scale, and the changed location.

FIG. 13B is a flowchart of another embodiment of a method for creating a modified virtual object using an annotation and the virtual object. As shown in FIG. 13B, the virtual object is identified from storage (1341b). The annotation and other annotations (if available) are identified from storage (1342b). The modified virtual object is generated as a combination of the virtual object, an indicator of the annotation, and indicators of the other annotations (if available) (1343b), where the indications of the annotation(s) are placed at locations at which the user placed the annotations relative to the virtual object. The modified virtual object is transmitted to a CAD software program for viewing by a user (1344b).

FIG. 14B is a graphical representation of the method for creating a modified virtual object of FIG. 13B. As shown in FIG. 14B, an annotation user interface enables a user to apply the different annotations 1401 through 1404 to a virtual object 1400 in the same manner as described with respect to FIG. 14A. After annotations are defined by a user in the annotation user interface, a processor (e.g., the platform 110) generates the modified virtual object as a combination of the virtual object 1400 and indicators 1411, 1412, 1413, and 1414 of the annotations 1401, 1402, 1403, and 1414. In one embodiment, the indicators 1411 through 1414 include the annotations 1401 through 1404 as designated by the user in the annotation user interface (e.g., the notes, designations, arrows, etc., of each annotation). The new virtual object may include the indicators 1411 through 1414 as parts of the new virtual object. The modified virtual object is provided to the CAD software program for display next to the virtual object (or a version thereof) so a user of the CAD software program can view the modified virtual object as a reference while incorporating the annotations into the virtual object (or a version thereof). As shown, after the modified virtual object is displayed on a CAD software program user interface, a user modifies the virtual object on the same CAD software program user interface to include the other part, the new color, the changed scale, and the changed location.

FIG. 13C is a flowchart of another embodiment of a method for creating a modified virtual object using an annotation and the virtual object. As shown in FIG. 13C, the virtual object is identified from storage (1341c). For each of one or more annotations, the following steps 1342c through 1344c are carried out. The annotation is identified from storage (1342c). The type of annotation is identified (1343c) Example types of annotations include changing a characteristic (e.g., color, texture, size) of a part of the virtual object, changing the location of a part of the virtual object, replacing a part of the virtual object with another part. The part(s) of the virtual object to which the annotation applies are identified (1344c). First instructions are generated for a CAD software program, where the first instructions cause the CAD software program to apply the annotation(s) to generate the modified virtual object as the virtual object with the applied annotation(s) (1345c). Second instructions are generated for the CAD software program, where the second instructions cause the CAD software program to display descriptor(s) that the annotation(s) are applied (1346c) (e.g., text or image descriptors describing the annotation(s)). The first and second instructions (and optionally the virtual object) are transmitted to the CAD software program (1347c). The first and second instructions are executed using the CAD software program to generate the modified virtual object as the virtual object modified with the applied annotation(s), and the descriptors of the annotation(s) that were applied (1348c).

FIG. 14C is a graphical representation of the method for creating a modified virtual object of FIG. 13C. As shown in FIG. 14C, an annotation user interface enables a user to apply the different annotations 1401 through 1404 to a virtual object 1400 in the same manner as described with respect to FIG. 14A. After annotations are defined by a user in the annotation user interface, a processor (e.g., the platform 110) generates (i) first instructions that cause a CAD software program to apply the annotations 1401, 1402, 1403 and 1404 so as to generate the modified virtual object as the virtual object 700 with the annotations 1401, 1402, 1403 and 1404 applied, and also (ii) second instructions that cause the CAD software program to display descriptors 1421, 1422, 1423, and 1424 indicating that respective annotations 1401, 1402, 1403 and 1404 are applied. The first and second instructions are provided to the CAD software program, which executes the first and second instructions to generate the modified virtual object, and to generate the descriptors 1421 through 1424. As shown, the modified virtual object includes the other part, the new color, the changed scale, and the changed location. The descriptors 1421 through 1424 are included separate from the modified virtual object, but at similar relative locations to the modified virtual object as the annotations 1401 through 1404 were located relative to the virtual object 1400. By way of example, the first and second instructions may be different code scripts that are compatible with and recognized by the CAD software program, and that instruct the CAD software program to respective modify the virtual object (or a version thereof) with the designated annotation and show the descriptors 1421 through 1424.

FIG. 14D is another graphical representation of the method for creating a modified virtual object of FIG. 13C. The implementation of FIG. 14D is the same as the implementation of FIG. 14C except the descriptors 1421, 1422, 1423, and 1424 are not displayed at similar relative locations to the modified virtual object as the annotations 1401 through 1404 were located relative to the virtual object 1400. Instead, the descriptors 1421 through 1424 are shown in a different location of the CAD software program user interface relative to a location of the modified virtual object.

Another embodiment of a process for making smart annotations is described below. The process uses a dictionary of terms that can be used to automatically make modifications to a composite 3D object. The user views a 3D object in virtual environment (also referred to herein as “Workspaces”). After the user decides the 3D object needs modifications, the user uses a dictionary of terms to make one or more annotations on the 3D object describing the required modifications (e.g., recognizable terms such “change”, “move”, “resize”, or others, in addition to identifiers of parts of a virtual object to which the terms apply). In one embodiment, each term in the dictionary of terms is stored in memory along with a code script that causes a software program to make the modification to the virtual object that is described by that term. The user repeats the previous step as much as necessary to designate any number of modifications using the dictionary of terms. The user exports the annotations. The system captures each annotation as a tuple of: 3D object identifier, subcomponent identifier, part number, and annotation designated by the user. The tuples are stored in a file in memory. The user or another user opens a virtual environment creator and loads the 3D object. The user imports the annotations file and requests the system to apply the annotations. For each tuple in the file, the system: identifies which part of the 3D object requires modification; identifies the type of modification is being requested; and the system applies the modification to the part. The user saves the modified 3D object.

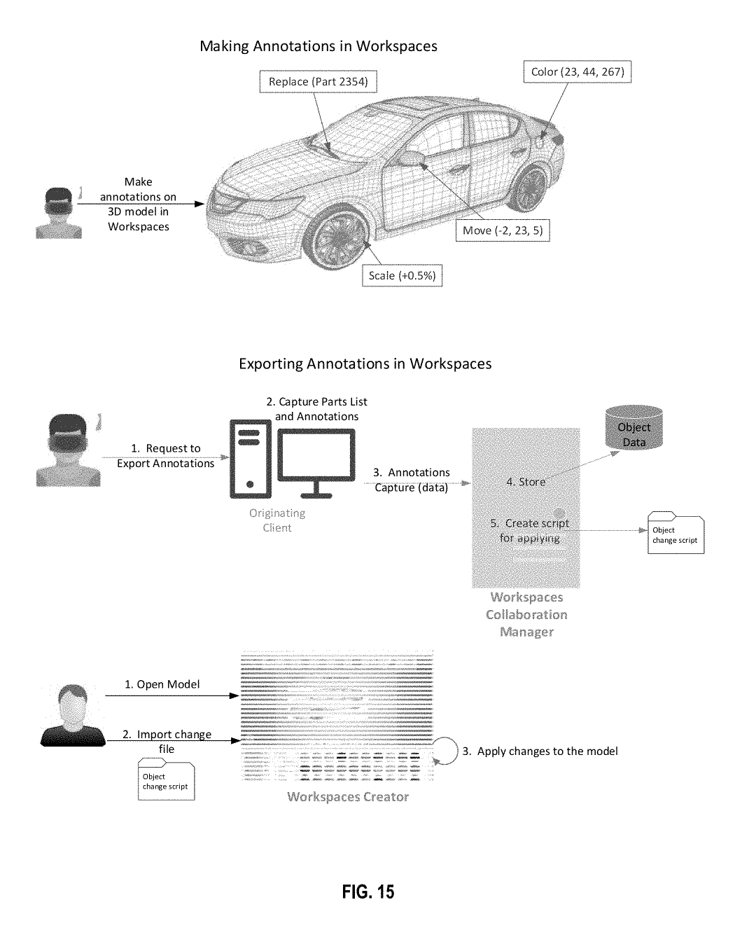

One embodiment of the above process is illustrated in FIG. 15. As shown in FIG. 15, annotations are made relative to a 3D model (e.g., a virtual object) in Workspaces (e.g., a software tool for displaying the virtual object and allowing a user to make annotations). A request to export the annotations is made by the user, after which a parts list for the 3D model and the annotations are captured by an originating client (e.g., determined and stored at a user device 120). Captured annotations are transmitted from the originating client to storage (e.g., the platform 110), and one or more scripts for applying the annotations are created and stored as a file or files (e.g., by the platform 110). Another user later opens the 3D model, or a version thereof, using Workspaces Creator (e.g., a CAD software program). The other user imports any of the files of the scripts, and the Workspaces Creator executes the scripts to apply the changes designated by the annotations to the 3D model or the version thereof.

### Creating Journal Entries

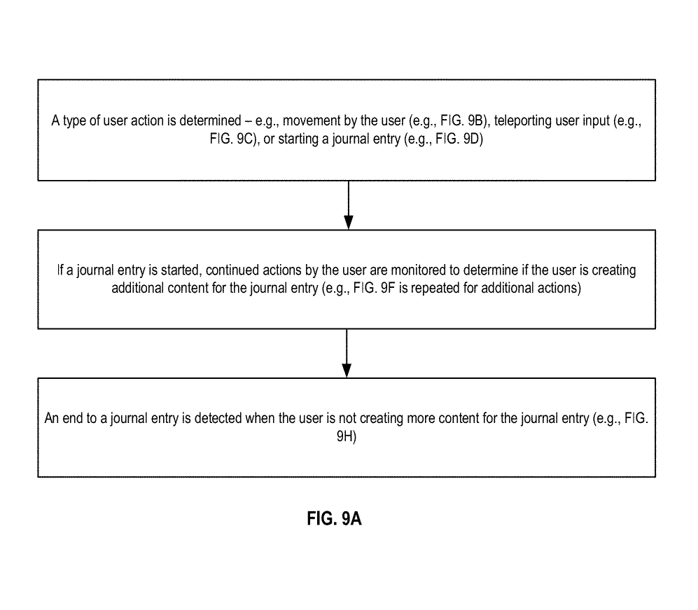

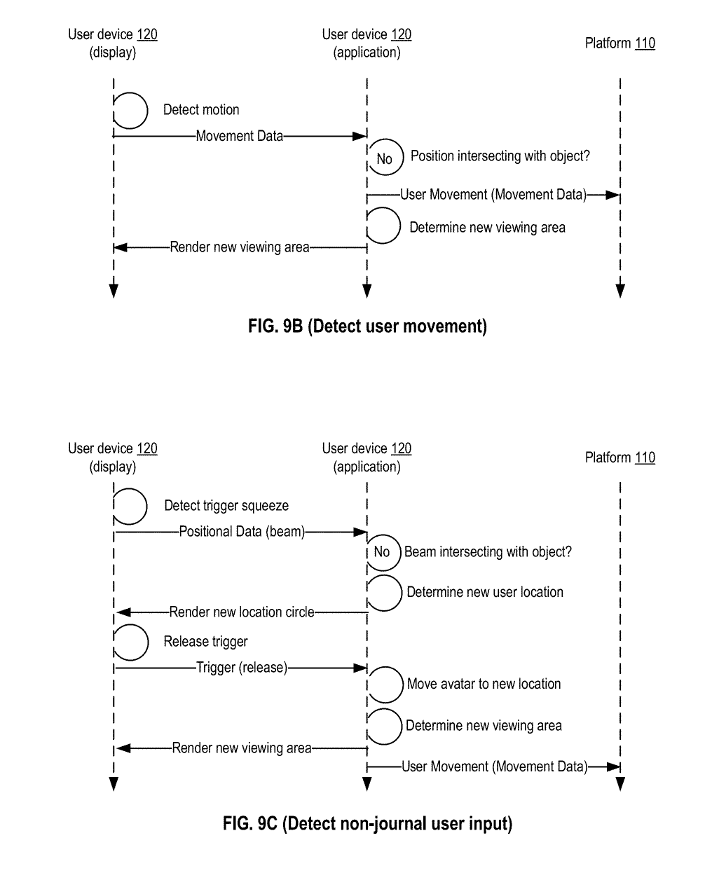

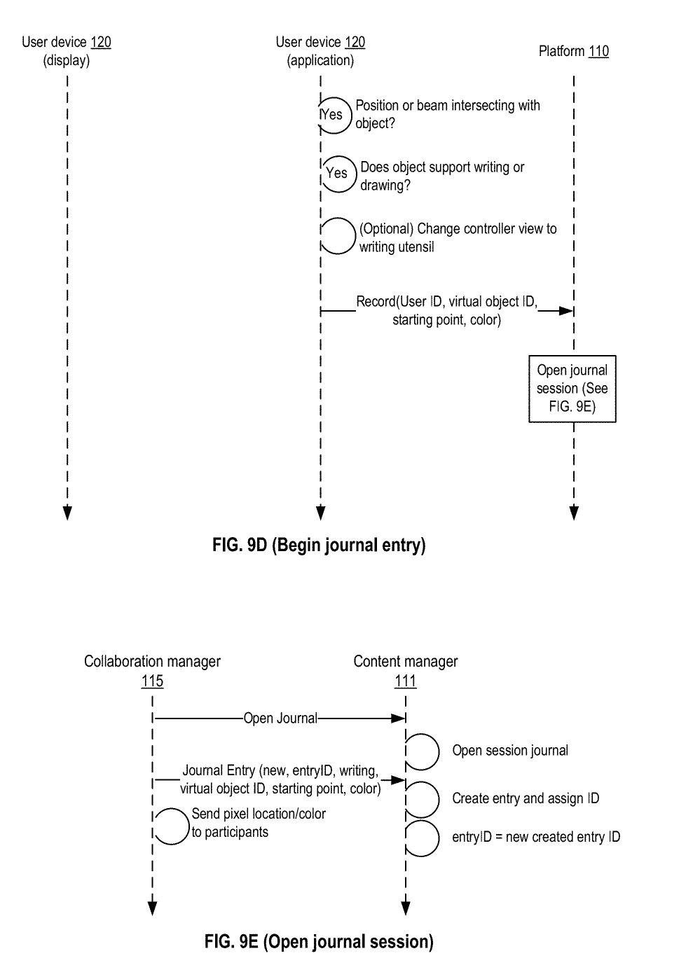

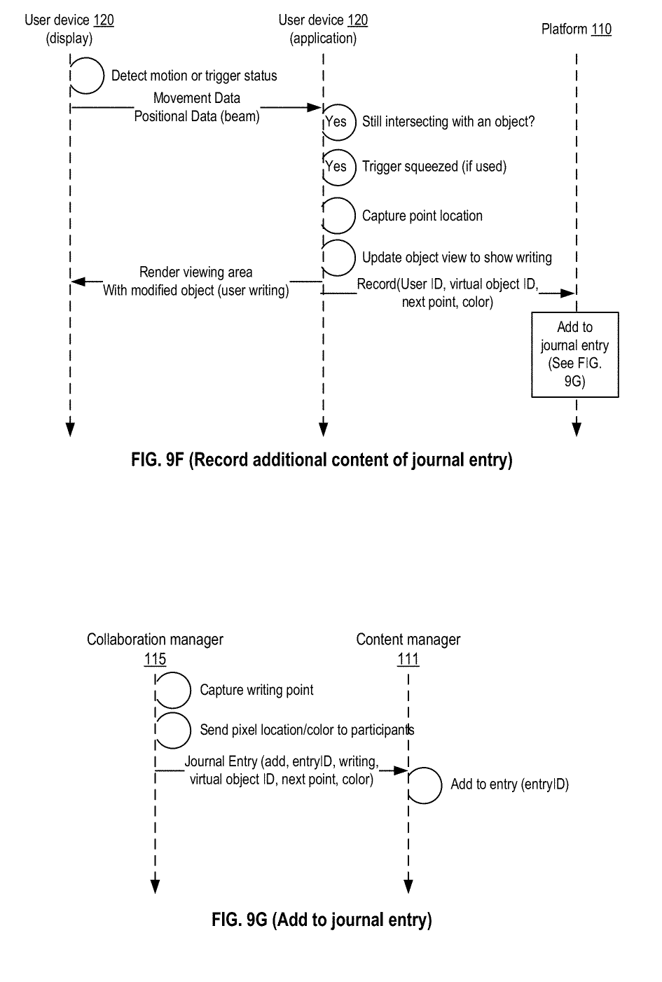

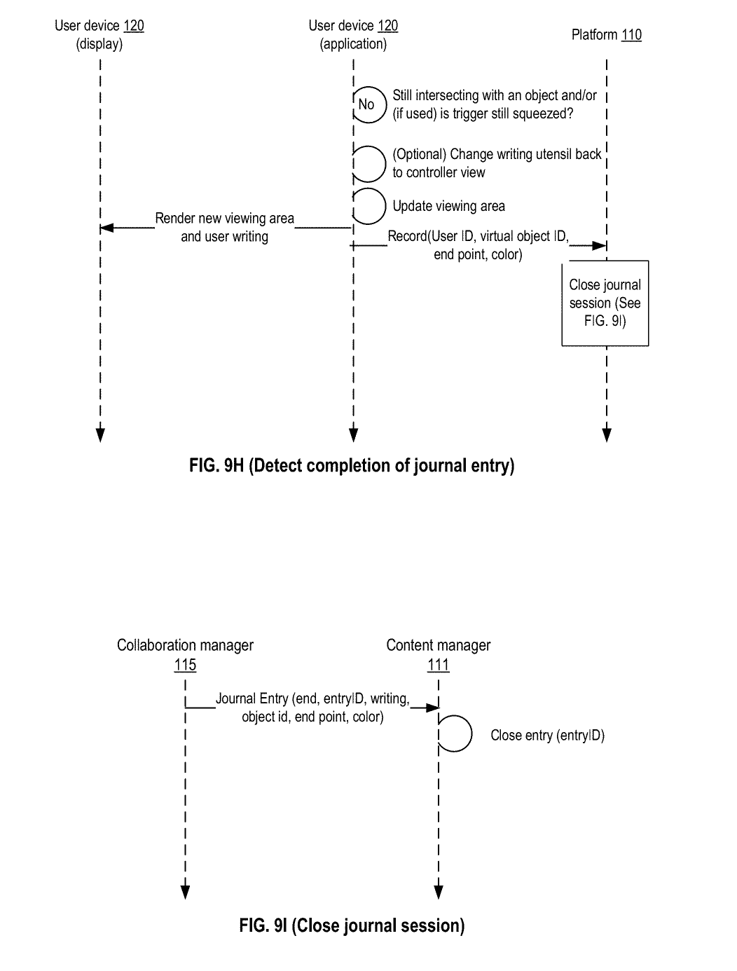

A method for detecting and capturing a journal entry in a virtual environment is shown in FIG. 9A. As shown in FIG. 9A, a type of user action is determined—e.g., movement by the user (e.g., FIG. 9B), teleporting of the user to a new position (e.g., FIG. 9C), or starting a journal entry (e.g., FIG. 9D). If a journal entry is started, continued actions by the user are monitored to determine if the user is creating additional content for the journal entry (e.g., FIG. 9F is repeated for additional actions). Finally, an end to a journal entry is detected when the user is not creating additional content for the journal entry (e.g., FIG. 9H). The method results in reduced resource use by limiting the size of a journal entry. Monitored actions that indicate the user is creating additional content for a journal entry can be combined and saved in a single journal entry, while a single action that indicates the user has created a journal entry without additional content can be saved as its own journal entry.

In some embodiments, the start of a journal entry is determined when a user selects an option that allows the user to create a journal entry, and also selects the virtual object with which the journal entry is to be associated. In other embodiments, the start of a journal entry is determined when a virtual position of the user (or a tool used by the user) intersects with a virtual object, and any continued intersections are interpreted as continued actions indicative of the user creating additional content for the journal entry. In some implementations, a journal entry is not started until a user command (e.g., trigger pull of a mechanical tool, voice command or other) is received in addition to determining that the virtual position intersects with the point on the virtual object. One embodiment of intersection includes the virtual position intersecting a point on the virtual object. Another embodiment of intersection includes the virtual position intersecting a point in the virtual environment that is within a threshold distance from the virtual object (so the virtual position does not need to exactly intersect with a point of the virtual object).

FIG. 9B depicts a sub-process for detecting user movement. As shown, motion from one position to a new position in the virtual environment by the user or a tool is detected. The new position is compared to positions of points of a virtual object to determine if the new position is intersecting any point of the virtual object. If the new position is not intersecting any point of the virtual object, the new position is recorded and used to determine a new viewing area for the user. For details about next steps after the new position is found to intersect a point of the virtual object, refer to FIG. 9D.

FIG. 9C depicts a sub-process for detecting whether a user is teleporting to a new position. Other types of user input for other purposes can also be monitored. As shown, a trigger squeeze is detected. The trigger squeeze may emit a positional beam into the virtual environment. If the positional beam does not intersect a virtual object, a new location circle is rendered for view by the user. If the trigger is released, the position of the user is moved to the position of the new location circle, and used to determine and render a new viewing area for the user. For details about next steps after the positional beam is found to intersect the virtual object, refer to FIG. 9D.

FIG. 9D depicts a sub-process for determining when a journal entry starts (e.g., the next steps after a new position is found to intersect a point on the virtual object during FIG. 9B and/or after a positional beam is found to intersect the virtual object during FIG. 9C). Any new viewing area may be determined and rendered for display to the user as needed. As shown in FIG. 9D, a determination is made as to whether a journal entry can be created for the virtual object, or created by the user. If not, no journal entry is allowed. If a journal entry can be created for the virtual object and by the user, a depiction of the tool in view of the user is optionally changed to a writing utensil or other icon to alert the user he or she can begin a journal entry. Different data is recorded, including an ID of the user, an ID of the virtual object, a starting point (e.g., the point of intersection) of the journal entry, and a color of the journal entry at the starting point. The sub-process proceeds to opening a journal entry session, as shown in FIG. 9E, which includes opening a session journal entry, and storing data for the journal entry (e.g., a journal entry identifier, the starting point and its color, the ID of the virtual object, among other data). The pixel location of the starting point and its color are also sent to any other user devices for display to users of those devices if the starting point is in view of those users.

FIG. 9F depicts a sub-process for determining if the user is creating additional content for an existing journal entry. As shown, motion from one position to a new position in the virtual environment by the user, a tool operated by the user, or a positional beam is detected. Alternatively, a trigger release or squeeze may be detected (if used). If the new position does not intersect a point on the virtual object or if the trigger is released (when in use), the steps of FIG. 9H are followed to end the journal entry. If the new position is found to intersect a point on the virtual object, and if the trigger is still squeezed (when in use), the location of the intersection is recorded, a view of the virtual object in a viewing area of the user is updated to show a pixel color representing the journal entry at the point of intersection, and additional data is recorded, including the ID of the user, the ID of the virtual object, a next point (e.g., the current point of intersection) of the journal entry, and a color of the journal entry at the next point. The sub-process proceeds to adding to an open journal entry session, as shown in FIG. 9G, which includes storing new data for the journal entry (e.g., the journal entry identifier, the next point and its color, the ID of the virtual object, among other data). The pixel location of the next point and its color are also sent to any other user devices for display to users of those devices if the next point is in view of those users.

FIG. 9H depicts a sub-process for determining when an end to a journal entry is detected. As shown, if the new position does not intersect a point on the virtual object, or if the trigger is released (when in use), the depiction of the tool in view of the user is optionally changed to a controller or other image to alert the user the journal entry has ended. Any new viewing area may be determined and rendered for display to the user as needed. Data indicating the end of the journal entry is generated and stored, including the ID of the user, the ID of the object, an end point of the journal entry, and the color of that end point. The sub-process proceeds to closing the journal session, as shown in FIG. 9I, which includes storing final data for the journal entry (e.g., the journal entry identifier, the end point and its color, the ID of the virtual object, among other data). The stored data may be later retrieved and displayed at the stored points relative to the virtual object.

Any and all of the methods shown in FIG. 9A through FIG. 9I may also be used to capture individual or combinations of annotations (e.g., drawings or other types of annotations) instead of journal entries (e.g., by replacing “journal entry” with “annotation” or “drawing” or “combination of annotations”).

Annotations and journals are available using VR technologies, AR technologies, or MR technologies. Annotations and journals may be made in an AR environment over a physical object by first determining a virtual representation of the physical object, and then associating the annotations or journal with that virtual representation.

### Other Aspects

Each method of this disclosure can be used with virtual reality (VR), augmented reality (AR), and/or mixed reality (MR) technologies. Virtual environments and virtual objects may be presented using VR technologies, AR technologies, and/or MR technologies.

The accompanying claims and their equivalents are intended to cover such forms or modifications as would fall within the scope of the disclosure. For instance, the example apparatuses, methods, and systems disclosed herein may be applied to VR, AR, and MR technologies. The various components illustrated in the figures may be implemented as, for example, but not limited to, software and/or firmware on a processor or dedicated hardware. Also, the features and attributes of the specific example embodiments disclosed above may be combined in different ways to form additional embodiments, all of which fall within the scope of the disclosure.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. In addition, use of “in an embodiment” or similar phrasing is not intended to indicate a different or mutually exclusive embodiment, but to provide a description of the various manners of implementing the inventive concepts described herein. Furthermore, the particular features, structures, or characteristics of such embodiments may be combined in any suitable manner in one or more embodiments.

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for modifying a virtual object in a virtual environment, the method comprising:
receiving at one or more processors, an identification of the virtual object within the virtual environment;
receiving, from a first user device communicatively coupled to the one or more processors, an annotation including one or more changes to be applied to the virtual object;
determining a type of the one or more changes based on the annotation;
determining a location of the one or more changes to the virtual object based on the annotation;
causing the virtual object to be modified as a modified virtual object using a computer-aided design (CAD) software program to implement the changes indicated in the annotation; and
displaying the modified virtual object within the virtual environment.

2. The method of claim 1 further comprising storing a plurality of dictionary terms to a dictionary stored in memory, each dictionary term of the dictionary including a pre-defined action associated with the one or more changes'

3. The method of claim 2 wherein the dictionary further comprises a list of parts of the virtual object.

4. The method of claim 3 wherein the determining a part of the virtual object and the determining a location of the one or more changes is further based on one or more dictionary terms included in the annotation.

5. The method of claim 3 wherein the CAD software program implements the changes based on one or more dictionary terms included in the annotation.

6. The method of claim 1 further comprising storing the annotation in a memory, each stored annotation having a tuple of a virtual object identifier, a subcomponent identifier, a part number, and the annotation.

7. The method of claim 1 further comprising automatically applying the annotation by the one or more processors.

8. The method of claim 1 further comprising receiving an instructions from the user to device to apply the annotation.

9. The method of claim 1 further comprising displaying the modified virtual object and the drawing via a second user device.

10. A non-transitory computer-readable medium comprising instructions for modifying a virtual object in a virtual environment, that when executed by one or more processors cause the one or more processors to:
receive an identification of the virtual object within the virtual environment;
receive, from a first user device communicatively coupled to the one or more processors, an annotation including one or more changes to be applied to the virtual object;
determine a type of the one or more changes based on the annotation;
determine a location of the one or more changes to the virtual object based on the annotation;
cause the virtual object to be modified as a modified virtual object using a computer-aided design (CAD) software program to implement the changes indicated in the annotation; and
display the modified virtual object within the virtual environment.

11. The non-transitory computer-readable medium of claim 10 further comprising storing a plurality of dictionary terms to a dictionary stored in memory, each dictionary term of the dictionary including a pre-defined action associated with the one or more changes'

12. The non-transitory computer-readable medium of claim 11 wherein the dictionary further comprises a list of parts of the virtual object.

13. The non-transitory computer-readable medium of claim 12 wherein the determining a part of the virtual object and the determining a location of the one or more changes is further based on one or more dictionary terms included in the annotation.

14. The non-transitory computer-readable medium of claim 12 wherein the CAD software program implements the changes based on one or more dictionary terms included in the annotation.

15. The non-transitory computer-readable medium of claim 10 further comprising storing the annotation in a memory, each stored annotation having a tuple of a virtual object identifier, a subcomponent identifier, a part number, and the annotation.

16. The non-transitory computer-readable medium of claim 10 further comprising automatically applying the annotation by the one or more processors.

17. The non-transitory computer-readable medium of claim 10 further comprising:
receiving an instructions from the user to device to apply the annotation; and
applying the annotation to the virtual object.

18. The non-transitory computer-readable medium of claim 10 further comprising displaying the modified virtual object and the drawing via a second user device.
